(19) United States
(12) Patent Application Publication
(10) Pub. No.: US 2018/0326947 A1
(43) Pub. Date: Nov. 15, 2018

(54) OPERATING A KEY FOB IN A CAR SHARING SYSTEM

(71) Applicant: GM Global Technology Operations LLC, Detroit, MI (US)

(72) Inventors: Christopher L. Oesterling, Troy, MI (US); Dwayne A. Crocker, Lake Orion, MI (US); Robert Miles, Austin, TX (US); Nathaniel H. Williams, Berkley, MI (US)

(21) Appl. No.: 15/595,330

(22) Filed: May 15, 2017

(51) Int. Cl. B60R 25/24; G07C 9/00; G07C 5/00

(52) U.S. Cl. CPC B60R 25/241; G07C 9/00309; G07C 5/008; G07C 9/00103; G07C 2009/00865; G07C 9/00896; B60R 2325/205; G07C 2009/00992; G07C 9/00817

(57) ABSTRACT

A system and method of operating a key fob for use in a car sharing vehicle access system, including the steps of: authenticating the key fob for use with a specific vehicle; receiving a key fob activation command; obtaining an authorization to control, using the vehicle commands, at least some vehicle functions on the vehicle; in response to obtaining the authorization, enabling transmissions of any one or more of the vehicle commands from the key fob; receiving a user input requesting that one of the vehicle commands be sent to the vehicle; sending the requested one of the vehicle commands to the vehicle; and subsequently removing the authorization such that the key fob is disabled from further controlling the vehicle functions.

### INTRODUCTION

The disclosure relates to allowing access to enabling and operating a key fob in a car sharing system.

Now, many vehicle components, devices, and modules desire to send to or receive data from a remote server (e.g., a vehicle backend service facility) to short-range wireless (SRWC) devices. These SRWC devices, such as smartphones or key fobs, may connect to a vehicle via short-range wireless communications (SRWC). Such SRWC connections or devices may be authorized and/or authenticated by the vehicle and, when properly authorized and authenticated, the mobile device may send information to the vehicle. In some scenarios, the SRWC devices can be used to permit access to the vehicle through being configured and used a wireless key.

### SUMMARY

According to a first embodiment, there is provided a method of operating a key fob for use in a car sharing system, including the steps of: authenticating the key fob for use with a specific vehicle, the key fob being associated with a set of vehicle commands that may be sent wirelessly from the key fob to the vehicle, wherein the key fob can be activated and deactivated wirelessly to selectively enable and disable sending of the vehicle commands; receiving a key fob activation command; obtaining an authorization to control, using the vehicle commands, at least some vehicle functions on the vehicle; in response to obtaining the authorization, enabling transmissions of any one or more of the vehicle commands from the key fob; receiving a user input requesting that one of the vehicle commands be sent to the vehicle; sending the requested one of the vehicle commands to the vehicle; and subsequently removing the authorization such that the key fob is disabled from further controlling the vehicle functions.

According to other embodiments, there is provided that of the first embodiment further including any one or more of the following:
wherein the authentication step includes pairing the key fob to a vehicle wireless device (VWD) installed in the vehicle, wherein the sending step is carried out via the VWD;
wherein the authentication step includes obtaining a secret key that can be used to carry out secure wireless communications with a vehicle wireless device (VWD) or other vehicle system module of the vehicle;
wherein the key fob activation command is received from a handheld wireless device (HWD) or from a user via a button included on the key fob;
wherein the step of receiving a key fob activation command is carried out in response to user input into an application on a handheld wireless device (HWD);
wherein the obtaining authorization step includes sending an activation request message to a handheld wireless device (HWD) and, subsequently, receiving a delegated digital key from a vehicle wireless device (VWD), wherein the delegated digital key provides the key fob with authorization to control one or more of the vehicle functions;
further comprising the step of sending a confirmation response message to the VWD in response to the obtaining authorization step;
wherein the step of receiving the delegated digital key comprises receiving at the key fob from the VWD an access granted message that includes the delegated digital key and that is signed using a secret key that was established during the authentication step;
further comprising the steps of: sending a challenge request message to the VWD in response to the receiving user input step; and receiving a challenge response message from the VWD in response to sending the challenge request message to the VWD, wherein the challenge response message includes a vehicle challenge token;
wherein the user input is received via a button on the key fob;
wherein the removing step includes disabling any further transmissions of the vehicle commands from the key fob; and
wherein the removing step is carried out based on a predetermined time limit, on receipt of a disable key fob command from a handheld wireless device (HWD), or on receipt of the disable key fob command from a vehicle wireless device (VWD).

According to a second embodiment, there is provided a method of controlling a key fob for use in a car sharing system, including the steps of: obtaining vehicle access credentials at a user's handheld wireless device (HWD), wherein the vehicle access credentials include a digital vehicle key that allows the user to access and/or operate the vehicle through sending of vehicle commands to the vehicle, wherein the vehicle commands instruct the vehicle to carry out one or more vehicle functions; activating a key fob for use with the vehicle using the HWD; and controlling one or more vehicle functions via manual input to the key fob.

According to other embodiments, there is provided that of the second embodiment further including any one or more of the following:
wherein the activation step includes sending an enable key fob message to a vehicle wireless device (VWD) installed in the vehicle, and wherein the receipt of the enable key fob message by the VWD causes the VWD to carry out communications with the key fob to enable the key fob for sending vehicle commands to the vehicle;
wherein the activation step includes sending an activation request message from the key fob to the HWD;
further comprising the step of sending a disable key fob request to a vehicle wireless device (VWD); and
further comprising the step of receiving a disable confirmation message from the VWD, wherein the disable confirmation message indicates that the key fob has been disabled from controlling the one or more vehicle functions.

According to a third embodiment, there is provided a key fob including a housing, one or more manual input sensors, a short range wireless communications (SRWC) circuit, an electronic processor connected to receive input from the sensor(s) and to send and receive messages via the SRWC circuit, computer-readable memory, a program stored in the memory and operable upon execution by the processor to cause the processor to process inputs received via the sensor(s) and messages received via the SRWC circuit and to send via the SRWC circuit vehicle commands based on the received inputs and/or messages; wherein the processor is operable under control of the program to send the vehicle commands only when enabled via one or more messages received via the SRWC circuit.

### BRIEF DESCRIPTION OF THE DRAWINGS

Exemplary embodiments will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of a key fob that can be used to carry out at least part of the methods disclosed herein;

FIG. 3 is a flowchart illustrating a method of providing one or more vehicle functions at a vehicle using the key fob of FIG. 2;

FIG. 4 is a flow diagram illustrating a method of pairing the key fob of FIG. 2 with a vehicle;

FIG. 5 is a flow diagram illustrating a method of enabling or configuring the key fob of FIG. 2 with a vehicle;

FIG. 6 is a flow diagram illustrating a method of carrying out one or more vehicle operations through operation of the key fob of FIG. 2; and

FIG. 7 is a flow diagram illustrating a method of disabling the key fob of FIG. 2 with a vehicle.

### DETAILED DESCRIPTION

The system and methods below enable a key fob (or other SRWC device) to be delegated vehicle access for a certain period of time such that the key fob can send certain commands to the vehicle and/or permit user control of the vehicle when the key fob is in the presence of the vehicle (e.g., within a predetermined range). The method can be used in a scenario in which a user makes a reservation to use a vehicle (e.g., as a part of a car system). Once the reservation has been successfully made, the user may then be permitted access to the vehicle using a handheld wireless device (HWD), such as their smartphone. The HWD can then act as a passive entry/passive start (PEPS) key that allows the user to access and operate the vehicle. In certain scenarios, the user may desire to allow another person to access and/or operate the vehicle without having to relinquish control of their HWD. As discussed below, certain embodiments of the method and system herein allow the user to delegate certain permissions to a separate key fob (or other SRWC device). This may be useful where the user desires to permit a third party to use the vehicle for a certain amount of time, within a certain range, and/or for certain purposes (e.g., for carrying out certain vehicle functions). For example, when a user who has reserved a vehicle desires to drop their vehicle off with a valet service, the user may rather provide the valet service the key fob with limited permissions than provide their HWD to the valet service.

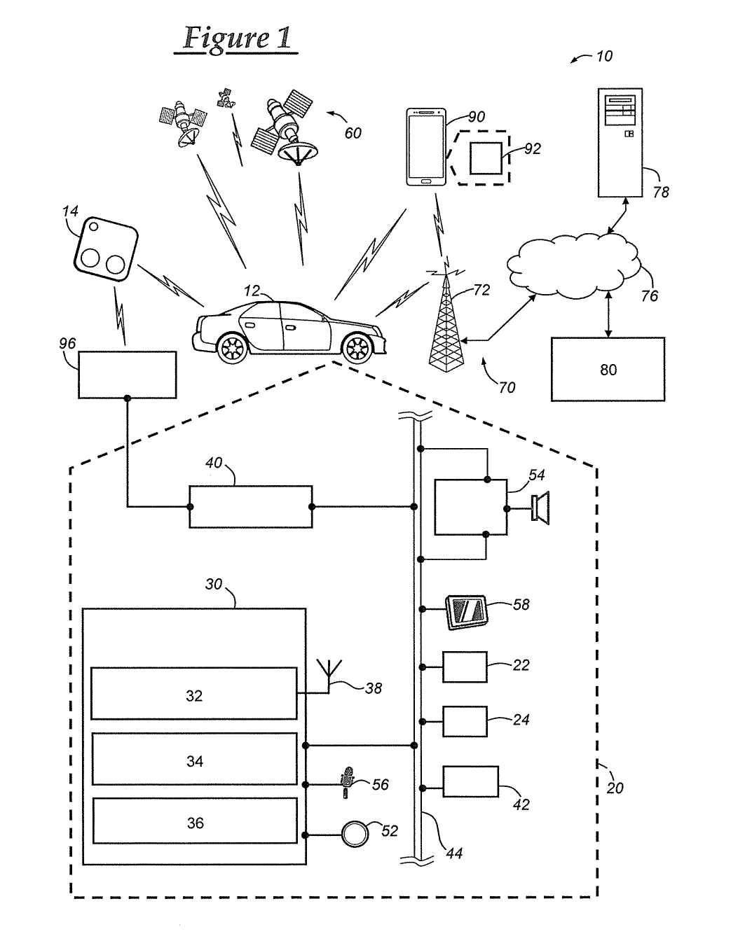

Referring now to FIG. 1, there is shown an operating environment that comprises a car sharing system 10 and that can be used to implement the method disclosed herein. Car sharing system 10 generally includes a vehicle 12 with a telematics unit 30, a key fob 14, a constellation of satellites 60, one or more wireless carrier systems 70, a land communications network 76, a computer 78, a remote facility 80, a handheld wireless device (HWD) 90, and a vehicle wireless device (VWD)f 96. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such car sharing system 10; however, other systems not shown here could employ the disclosed method as well.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., telematics unit 30, HWD 90). Carrier system 70 can implement any suitable communications technology, including for example GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof.

Computers 78 (only one shown) can be some of a number of computers accessible via a private or public network such as the Internet. Each such computer 78 can be used for one or more purposes, such as a web server accessible by vehicle 12. Other such accessible computers 78 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a car sharing server which coordinates reservations and/or registrations from a plurality of users who request to use a vehicle as part of a car sharing service; or a third party repository to or from which vehicle data or other information is provided, whether by communicating with the vehicle 12, remote facility 80, or both. A computer 78 can also be used for providing Internet connectivity such as DNS services or as a network address server that uses DHCP or other suitable protocol to assign an IP address to the vehicle 12.

Remote facility 80 may be designed to provide the vehicle electronics 20 and HWD 90 with a number of different system back-end functions. For example, remote facility 80 may be used in part to implement a car sharing service. In such a case, remote facility 80 may coordinate reservations and/or registrations of vehicles, store data pertaining to the reservations and/or registrations or other aspects of the car sharing service, and/or provide authentication and authorization data to SRWC devices, users, and/or vehicles. The remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 76. A database at the remote facility can store account information such as subscriber authentication information, vehicle identifiers, profile records, behavioral patterns, and other pertinent subscriber information. Data transmissions may also be conducted by wireless systems, such as IEEE 802.11x, GPRS, and the like. Although the illustrated embodiment has been described as it would be used in conjunction with a manned remote facility 80 using a live advisor, it will be appreciated that the remote facility can instead utilize a VRS as an automated advisor or, a combination of the VRS and the live advisor can be used. Information or data stored at the remote facility 80 can be sent to one or more vehicles or other devices (e.g., HWD 90) to carry out numerous functionality and services, such as car sharing services. The vehicle 12 and/or HWD 90 can send data or information to the remote facility, which can then store such information.

The handheld wireless device (HWD) 90 is a SRWC device (i.e., a device capable of SRWC) and may include: hardware, software, and/or firmware enabling cellular telecommunications and SRWC as well as other mobile device applications, such as a car sharing application 92. The hardware of the HWD 90 may comprise: a processor and memory (e.g., non-transitory computer readable medium configured to operate with the processor) for storing the software, firmware, etc. The HWD processor and memory may enable various software applications, which may be preinstalled or installed by the user (or manufacturer) (e.g., having a software application or graphical user interface or GUI). One implementation of an application may enable a vehicle user to communicate with the vehicle 12 and/or control various aspects or functions of the vehicle, some of which are listed above. Additionally, one or more applications may allow the user to connect with the remote facility 80 or call center advisors at any time.

The processor of the HWD may also execute an operating system for the handheld device, such as Android™, iOS™, Microsoft Windows™, and/or other operating systems. The operating system may provide a user interface and a kernel, thereby acting as a central control hub that manages the interfacing between the hardware and software of the device. Moreover, the operating system may execute mobile applications, software programs, and/or other software or firmware instructions. In one embodiment, the processor can execute a car sharing application that enables a user to make vehicle reservations and to enable operation of a key fob for use with a vehicle, as discussed below. The memory of HWD 90 may include RAM, other temporary powered memory, any non-transitory computer-readable medium (e.g., EEPROM), or any other electronic computer medium that stores some or all of the software needed to carry out the various external device functions discussed herein. In other embodiments, the memory of HWD 90 may be a non-volatile memory card, such as a Secure Digital™ (SD) card, that is inserted into a card slot of HWD 90.

HWD 90 can also include a short range wireless communications (SRWC) circuit and/or chipset and one or more antennas, which allows it to carry out SRWC, such as any of the IEEE 802.11 protocols, WiMAX™, ZigBee™, Wi-Fi Direct™, Bluetooth™, or near field communication (NFC). The SRWC circuit and/or chipset may allow HWD 90 to connect to another SRWC device. Additionally, HWD 90 can include a cellular chipset thereby allowing the device to communicate via one or more cellular protocols, such as GSM/GPRS technology, CDMA or CDMA2000 technology, and LTE technology. HWD 90 may communicate data over wireless carrier system 70 using the cellular chipset and an antenna.

In some embodiments, HWD 90 may be able to act as a passive entry key (e.g., a passive entry/passive start (PEPS) key, a smart key). For example, as discussed above, the HWD may be provided a key or other information that authorizes the device to access the vehicle. Such a scenario may be implemented in conjunction with a car sharing service whereby a remote facility coordinates car rentals or ride sharing, such as remote facility 80. The remote facility may generate and issue a virtual key (or digital key) (e.g., a string or array of bits) to the HWD 90 and to the vehicle 12. The HWD 90 may then securely pass the virtual key to the vehicle (e.g., via an established SRWC connection) and the vehicle may then determine if the virtual key is authorized to access the vehicle and/or the level of access the virtual key provides or is associated with (e.g., full vehicle functionality, only unlocking/locking features). The application may enable such virtual key management and functionality. As will be discussed in more detail below, once the vehicle successfully is reserved by a user using the car sharing application, the key fob 14 may be enabled and authorized to control certain vehicle functions through the wireless transmission of vehicle commands and/or may be enabled for a certain period of time.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and includes a GPS module 22, engine control unit (ECU) 24, a telematics unit 30, an on-board diagnostic (OBD) II port 40, other VSMs 42, and numerous other components and devices. Also, a vehicle wireless device (VWD) 96 may be installed into the OBD II port, or may be included in the vehicle electronics as a vehicle system module. Some or all of the different vehicle electronics may be connected for communication with each other via one or more communication busses, such as bus 44. Communications bus 44 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

The vehicle 12 can include numerous vehicle system modules (VSMs) as part of vehicle electronics 20, such as the GPS module 22, engine control unit (ECU) 24, telematics unit 30, OBD II port 40, and vehicle user interfaces 52-58, as will be described in detail below. The vehicle 12 can also include other VSMs 42 in the form of electronic hardware components that are located throughout the vehicle and, which may receive input from one or more sensors and use the sensed input to perform diagnostic, monitoring, control, reporting, and/or other functions. For example, other VSMs may include a center stack module (CSM), an infotainment unit, a powertrain control module, or a transmission control unit. Each of the VSMs 42 is preferably connected by communications bus 44 to the other VSMs, as well as to the telematics unit 30, and can be programmed to run vehicle system and subsystem diagnostic tests. One or more VSMs 42 may periodically or occasionally have their software or firmware updated and, in some embodiments, such vehicle updates may be over the air (OTA) updates that are received from a computer 78 or remote facility 80 via land network 76 and telematics unit 30. As is appreciated by those skilled in the art, the above-mentioned VSMs are only examples of some of the modules that may be used in vehicle 12, as numerous others are also possible.

Engine control unit (ECU) 24 may control various aspects of engine operation such as fuel ignition and ignition timing. ECU 24 is connected to communications bus 44 and may receive operation instructions from a body control module (BCM) (not shown) or other vehicle system modules, such as telematics unit 30, the VWD 96, or VSMs 42. In one scenario, the ECU 24 may receive a command from the BCM to start the vehicle—i.e., initiate the vehicle ignition or other primary propulsion system (e.g., a battery powered motor). In another scenario, the ECU 24 may be provided a signal from the BCM that directs the ECU 24 to not perform any operations or at least to not start the vehicle's engine or primary propulsion system.

Global position system (GPS) module 22 receives radio signals from a constellation of GPS satellites 60. From these signals, the module 22 can determine vehicle position which may enable the vehicle to determine whether it is at a known location, such as home or workplace. Moreover, GPS module 22 can provide this location data to wireless telematics unit 30, which can then use this data to identify known locations, such as a vehicle operator's home or workplace. Additionally, GPS module 22 may be used to provide navigation and other position-related services to the vehicle operator. Navigation information can be presented on the display 58 (or other display within the vehicle) or can be presented verbally such as is done when supplying turn-by-turn navigation. The navigation services can be provided using a dedicated in-vehicle navigation module (which can be part of GPS module 22), or some or all navigation services can be done via telematics unit 30 installed in the vehicle, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 78, for other purposes, such as fleet management and/or for use in a car sharing service. Also, new or updated map data can be downloaded to the GPS module 22 from the remote facility 80 via a vehicle telematics unit.

Vehicle electronics 20 also includes a number of vehicle user interfaces that provide vehicle occupants with a means of providing and/or receiving information, including pushbutton(s) 52, audio system 54, microphone 56, and visual display 58. As used herein, the term “vehicle user interface” broadly includes any suitable form of electronic device, including both hardware and software components, which is located on the vehicle and enables a vehicle user to communicate with or through a component of the vehicle. The pushbutton(s) 52 allow manual user input into the telematics unit 30 to provide other data, response, or control input. Audio system 54 provides audio output to a vehicle occupant and can be a dedicated, stand-alone system or part of the primary vehicle audio system. According to the particular embodiment shown here, audio system 54 is operatively coupled to both vehicle bus 44 and an entertainment bus (not shown) and can provide AM, FM and satellite radio, CD, DVD and other multimedia functionality. This functionality can be provided in conjunction with or independent of an infotainment module. Microphone 56 provides audio input to the telematics unit 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 58 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Telematics unit 30 includes a cellular chipset 32, processor 34, memory 36, and antenna 38. The telematics unit 30 can be an OEM-installed (embedded) or aftermarket device that is installed in the vehicle and that enables wireless voice and/or data communication over wireless carrier system 70 and via wireless networking. This enables the vehicle to communicate with remote facility 80, other telematics-enabled vehicles, or some other entity or device. The telematics unit can use radio transmissions to establish a communications channel (a voice channel and/or a data channel) with wireless carrier system 70 so that voice and/or data transmissions can be sent and received over the channel. By providing both voice and data communication, telematics unit 30 enables the vehicle to offer a number of different services including those related to navigation, car sharing, telephony, emergency assistance, diagnostics, infotainment, etc. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 32 for voice communications like hands-free calling, a wireless modem for data transmission, an electronic processing device 34, one or more digital memory devices 36, and a dual antenna 38. It should be appreciated that the modem can either be implemented through software that is stored in the telematics unit and is executed by processor 34, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi™ direct, Bluetooth™, Bluetooth Low Energy™ (BLE), or near field communication (NFC). When used for packet-switched data communication such as TCP/IP, the telematics unit can be configured with a static IP address or can set up to automatically receive an assigned IP address from another device on the network such as a router or from a network address server.

Processor 34 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 34 executes various types of digitally-stored instructions, such as software or firmware programs stored in memory 36, which enable the telematics unit to provide a wide variety of services. For instance, processor 34 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS module 22; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

Vehicle wireless device (VWD) 96 is a SRWC device that may communicate with HWD 90 and/or key fob 14. As shown in the exemplary embodiment of FIG. 1, VWD 96 can be installed (or plugged) into the OBD II port 40. In such an embodiment, VWD 96 can include an OBD II connector such that it may be removably plugged into the OBD II port of vehicle 12. Also, VWD 96 can include a SRWC circuit or chipset, a processor, and a memory device. The processor can execute various instructions, including an application that works in conjunction with car sharing application 92 on HWD 90, with other components of vehicle 12, and/or with the key fob 14. In one embodiment, VWD 96 can communicate with VSMs 42, HWD 90, and/or key fob 14 using one or more SRWC, as discussed more below.

In other embodiments, the VWD 96 can be a vehicle system module that is permanently installed to the vehicle electronics and that is connected to vehicle bus 44. In many embodiments, the VWD 96 may be specifically configured to be used with the method disclosed herein. In one embodiment, VWD 96 may be a standalone module or, in other embodiments, VWD 96 may be incorporated or included as a part of one or more other vehicle system modules, such as the telematics unit 30, a center stack module (CSM), body control module, an infotainment module, a head unit, and/or a gateway module. In some embodiments, the VWD 96 can be implemented as an OEM-installed (embedded) or aftermarket device that is installed in the vehicle.

VWD 96 can be configured to communicate wirelessly according to one or more wireless protocols, including short range wireless communications (SRWC) such as any of the IEEE 802.11 protocols, Wi-Fi™, WiMAX™, ZigBee™, Wi-Fi Direct™, Bluetooth™, Bluetooth Low Energy™ (BLE), or near field communication (NFC). As mentioned, VWD 96 can include a SRWC chipset or circuit, which can be used to enable the VWD 96 to transmit and receive SRWC, such as BLE. The SRWC chipset or circuit may allow the VWD 96 to connect to another SRWC device, such as HWD 90 or key fob 14.

In one embodiment, the VWD 96 may operate both when the vehicle is in a powered on state and when the vehicle is in a powered off state. As used herein, a “powered on state” is a state of the vehicle in which the ignition or primary propulsion system of the vehicle is powered on and, as used herein, a “powered off state” is a state of the vehicle in which the ignition or primary propulsion system (or primary mover) of the vehicle is not powered on. The operation or state of the VWD 96 may be controlled by another vehicle system module, such as by the BCM, telematics unit 30, or by an infotainment module. In the powered on state, the VWD 96 may always be kept “on” or supplied with power from a vehicle battery or other power source. In the powered off state, the VWD 96 may be kept in a low-power mode or may be supplied power periodically so that VWD 96 may wake up and perform operations.

For example, the VWD 96 may be periodically woken up by the BCM and, subsequently, the VWD 96 may perform a scan using SRWC, such as Bluetooth Low Energy™. This scan may be carried out over a predetermined period of time or may be based on various other vehicle or environmental states. The vehicle may repeat this process until a wireless message is detected or until the vehicle is turned on (i.e., switched from a powered off state to a power on state). For example, a message may be received from a HWD 90 or key fob 14. Upon detection of a SRWC device or receipt of a wireless message, the VWD 96 may communicate with the SRWC device by transmitting and receiving one or more wireless messages. These messages may include authenticating or otherwise verifying the identity of the SRWC device which sent (or ostensibly sent) the wireless message, authorizing the SRWC device using one or more authorization techniques (as discussed more below), and/or pairing the SRWC device and the VWD 96 (e.g., such as through Bluetooth™ or Bluetooth Low Energy™ pairing).

Once a connection is established between the VWD 96 and the SRWC device (e.g., key fob 14 or HWD 90), the VWD 96 may wait for a wireless message from the SRWC device that includes a specific command or function. Once VWD 96 receives such wireless message, the vehicle may authenticate and/or authorize the message and/or the SRWC device. Thereafter, the command or function may be interpreted, modified, and/or passed along to a specific VSM that is to perform the command or function. Alternatively, a new message based on the command or function may be generated and sent to another VSM.

A vehicle function is any function or operation that may be performed by the vehicle, including initiating or booting a telematics unit, a GPS module, an infotainment unit, a center stack module (CSM), or other VSM. Additionally, a vehicle function may be unlocking or locking the vehicle doors via the BCM, starting the ignition or primary propulsion system of the vehicle, disabling/enabling the vehicle ignition or primary propulsion system, heating or cooling passenger seats included in the vehicle, performing air conditioning or heating of the vehicle cabin, turning off/on or flashing headlights or other lights included in the vehicle, emitting an audible sound using a vehicle horn or speakers (such as those included in audio system 54), downloading information (e.g., information pertaining to a car sharing service reservation) or content data (e.g., audio/video playlists or files) from a remote facility 80 or computer 78 (including information that may be particular to the user of the SRWC device and/or associated with the SRWC device), downloading or uploading information and/or content data from or to the SRWC device, and/or performing various other operations or functions of the vehicle, many of which are described herein.

The key fob used in a car sharing system 10 is a SRWC device that may be implemented as any electronic device. It may be a standalone (dedicated) device and/or incorporated into any other device suitable for handing off to a valet or other delegated person. In the illustrated embodiment, key fob 14 may comprise a body or housing 100 that includes one or more switches or buttons for user interaction; further, the body may carry a processor, memory, and a wireless transmitter for the SRWC. Key fob 14 can be a detachable device that is carried in vehicle 12 and may be used to allow temporary control and access to vehicle 12. For example, key fob 14 may be enabled by a user through use of HWD 90 and VWD 96 (or other component of vehicle 12), as will be discussed in more detail below. As will be appreciated by those skilled in the art, the key fob memory may store and transmit a cryptographic key used for key fob validation at the vehicle. Some functions of the key fob 14 with the vehicle 12 may be passive (e.g., not requiring manual input by the user) such as enabling unlocking of the vehicle doors when the key fob is in the proximity of the vehicle, while other functions may require active input, such as a button press on the key fob 14 to, for example, unlatch a trunk of the vehicle. In any event, transmission of a wireless signal that includes the cryptographic key may initiate or control one or more of the vehicle functions such as locking and unlocking doors, starting the vehicle, operating a vehicle alarm system, operating a vehicle trunk release, etc. In one embodiment, the key fob may be paired with a particular vehicle, but may not be enabled until a user initiates and successfully completes a key fob enabling process using HWD 90 and/or vehicle 12. The key fob 14 can then remain enabled for a certain amount of time, as specified by the user using the HWD 90.

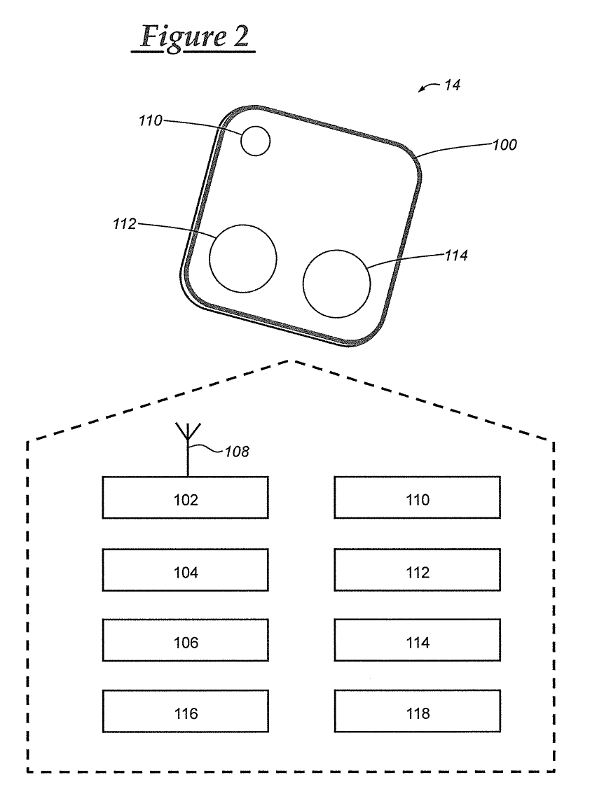

The key fob 14 is shown in FIG. 2, and includes a SRWC circuit 102, processor 104, memory 106, antenna 108, light emitting diode (LED) 110, one or more manual input sensors (e.g., buttons 112,114), battery 116, and charging port 118. The key fob 14 can include software instructions or applications that can be used with application 92 of HWD 90 to implement certain aspects of a car sharing service. The application can be carried out by processor 104 and can use data in memory 106 and/or data received via SRWC circuit 102. The application may also send messages to one or more other SRWC-enabled devices, such as HWD 90 and/or VWD 96. The key fob 14 can include a housing to retain and protect the electrical hardware components.

Key fob 14 can be configured to communicate wirelessly according to one or more wireless protocols, including short range wireless communications (SRWC) such as any of the IEEE 802.11 protocols, Wi-Fi™, WiMAX™, ZigBee™, Wi-Fi Direct™, Bluetooth™, Bluetooth Low Energy™ (BLE), or near field communication (NFC). The SRWC circuit 102 can be used to enable the key fob 14 to transmit and receive SRWC, such as BLE. The SRWC circuit may allow the key fob 14 to connect to another SRWC device, such as HWD 90, VWD 96, or another vehicle SRWC device. In one embodiment, the key fob 14 uses only BLE to communicate with HWD 90 and the VWD 96.

The key fob 14 can include a program or application that is stored in memory device 106 and that can be operated or executed by the processor. The operation and/or execution of the program can cause the processor to process received inputs from the one or more manual input sensors (e.g., buttons 112,114) and to process messages received via the SRWC circuit 102. Also, the program can cause the processor to send, via the SRWC circuit 102, vehicle commands to the vehicle (e.g., a VSM 42, or VWD 96) based on the received inputs and/or messages. The key fob 14 may only send vehicle commands when the key fob is enabled and/or when the key fob includes a delegated digital key stored in memory 106. At least in some embodiments, the enabling and disabling of the key fob can be carried out in part by the key fob communicating with the HWD 90 and/or the VWD 96 such that no backend connection (e.g., a connection to computer 78 or remote facility 80) is required. As used herein, when the key fob is “enabled” (or “activated”) then the key fob is capable of sending vehicle commands via wireless messages, wherein the wireless messages include the delegated digital key or some other valid authorization and/or authentication portion. When the key fob is not enabled (or “activated”) then the key fob is considered to be disabled (or “deactivated”).

As discussed in more detail below, the key fob can be enabled and provided with a delegated digital key that authorizes key fob 14 to send vehicle commands to the vehicle. The key fob can be delegated full control (i.e., the full extent of control that the HWD 90 includes) or may be delegated limited control, which can include only a subset of vehicle commands. In one embodiment, the key fob may be delegated control limited to those vehicle functions that allow access to the vehicle, such as unlocking/locking commands. In another embodiment, the key fob may be delegated control that allows the user of the key fob to access and/or operate the vehicle for a certain period of time, within a certain geographical range, and/or a combination thereof.

A user can operate application 92 using HWD 90 to initiate a key fob enabling process and, in doing so, may also specify certain parameters regarding the enablement of the key fob 14. For example, the user can specify a time period, an expiration time, or a length of time in which the key fob 14 will be enabled for use with the vehicle. Also, the user may specify a level of access that is to be granted to the key fob, such as certain vehicle functions (or set of functions) that the key fob can be permitted to control. The key fob may have a predefined set of vehicle commands that it may be permitted to send when it is enabled, or the set of vehicle commands can be specified by a user using application 92. In one scenario, the user may only desire that the key fob operator be permitted access to the cabin and trunk of the vehicle, and may thus the key fob may be permitted to control vehicle lock/unlock and trunk open vehicle functions. In another scenario, the user may desire to grant the key fob operator the ability to have full control of the vehicle (i.e., the full extent of control that the HWD 90 was provided via the reservation) for a certain period of time or for a predetermined length of time. In another example, the user can specify a maximum range that the vehicle may be driven within or a maximum amount of miles with which a key fob operator may drive the vehicle. The key fob may then automatically cause itself to become disabled upon the time period ending or the length of time expiring. Any combination of the level of control and/or time period for enablement can be used, all of which can be specified by a user using application 92.

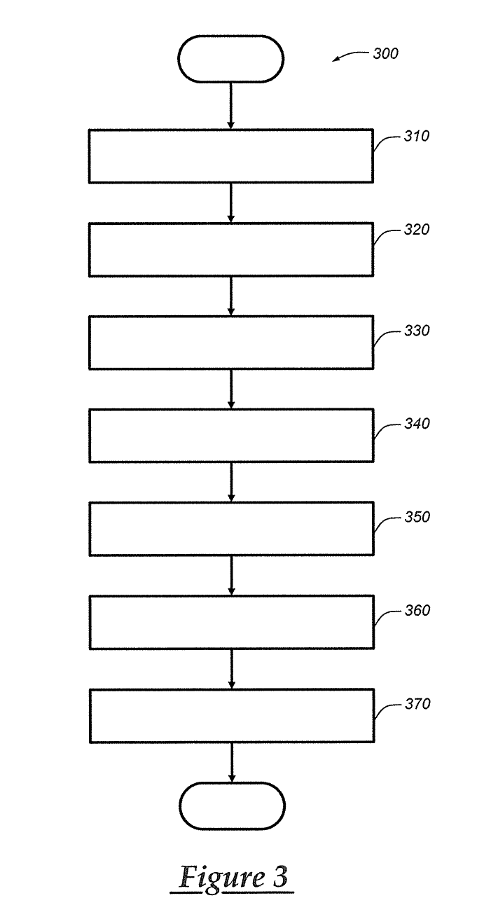

Electronic processor 104 can be connected to receive input from the sensor(s) and to send and receive messages via the SRWC circuit 102. Also, processor 104 can be any type of device capable of processing electronic instructions including microprocessors, microcontrollers, host processors, controllers, vehicle communication processors, and application specific integrated circuits (ASICs). Processor 104 executes various types of digitally-stored instructions, such as software or firmware programs stored in memory 106, which enable the key fob 14 to carry out a wide variety of functionality or services. For instance, processor 104 can execute programs or process data to carry out at least a part of the method discussed herein. In one embodiment, key fob 14 can include an application that enables the method described below in FIG. 3. Memory 106 may include RAM, other temporary powered memory, any non-transitory computer-readable medium (e.g., EEPROM), or any other electronic computer medium that stores some or all of the software needed to carry out the various external device functions discussed herein.

LED 110 can be a single LED or may be comprised of numerous LEDs. LED 110 can be used to indicate a certain state or status of the key fob 14, as will be discussed more in detail below. Buttons 112,114 can be used to control certain aspects of key fob 14 and/or may be used to command the vehicle 12 to perform some operation or function, such as a door unlock function. The key fob 14 also includes a battery 116 that is used to power the components 102-114. In one embodiment, the battery 116 is rechargeable via charging port 118, which can be connected to a power supply, such as a vehicle battery included in vehicle 12. The charging port can provide a universal serial bus (USB) type connection or any other suitable interface or connection means that are known to those skilled in the art. The vehicle 12 can include a docking port, slot, or portion that is reserved for storing or attaching the key fob, and which may include an interface with which the key fob may be connected to for purposes of charging the battery. In some embodiments, the charging port 118 can also be used for data transmissions between the key fob and another device, such as vehicle 12. For example, the charging port 118 can be a USB port to which a USB cable may be plugged into. The other connector of the USB cable can be connected to another device, such as vehicle 12. The cable can be used for charging the key fob and/or may be used for data transmissions.

With reference to FIG. 3, there is shown an embodiment of a method 300 of operating a key fob for use in a car sharing vehicle access system. The method 300 may be carried out in part or in whole by the key fob 14. Method 300 may be used in various scenarios. In one scenario, vehicle 12 may be used as part of a car sharing service. In such a scenario, a remote device (e.g., computer 78 or other device at a remote facility 80) may receive a request to use a vehicle from a user. The request may be made using an application installed on a mobile device, such as car sharing application 92 on HWD 90. The remote device may then process the request by identifying a vehicle that may appropriately fulfill the request, such as a vehicle available during times specified in the request and/or a vehicle that is within a certain proximity of the user or a desired location. Then, vehicle 12 and/or HWD 90 may be provided certain information pertaining to the vehicle 12, the HWD 90, key fob 14, and/or the user of the HWD 90. Specifically, the vehicle 12 may be provided with an identifier of the HWD 90 or the user, which may have been initially designated in the request or reservation sent from HWD 90. Likewise, the HWD 90 may be provided with a vehicle identifier, such as a vehicle identification number (VIN) or a media access control (MAC) address of the vehicle wireless device 96. The HWD 90 can now act as a vehicle key to allow the user of the HWD 90 to control certain vehicle functions, such as unlocking vehicle doors and starting the vehicle ignition (or primary mover).

However, in such a scenario, a user may desire to permit a third party user (e.g., a valet employee) access to the vehicle and/or an ability to control certain vehicle functions, such as unlocking vehicle doors and/or starting the vehicle ignition (or primary mover). It may be undesirable in certain instances for a user to give their handheld wireless device (e.g., smartphone) to the third party user; thus, method 300 provides for enabling a key fob that can be given to and used by the third party user. In some embodiments, the key fob may be activated for a certain amount of time or during a preset time range so that the third party user may only be permitted to access and/or operate the vehicle using the key fob for the certain amount of time or within the preset time range.

Method 300 begins with step 310 wherein the key fob 14 is authenticated for use with a specific vehicle, such as vehicle 12. As mentioned above, the key fob can be associated with a set of vehicle commands or functions that may be sent wirelessly from the key fob to the vehicle. The vehicle commands can take the form of wireless messages that include, specify, designate, or otherwise indicate a certain vehicle function to be carried out or that is requested to be carried out. Also, as will be discussed more in detail below, the key fob 14 can be activated and deactivated wirelessly to selectively enable and disable sending of the vehicle commands.

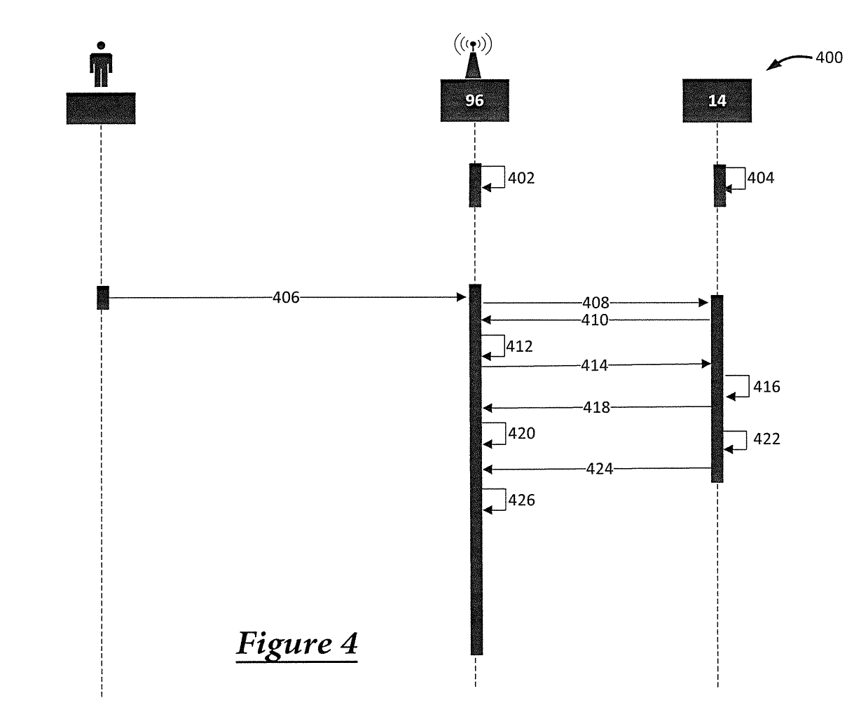

In one embodiment, the key fob 14 and the vehicle wireless device (VWD) 96 can be paired to one another such that a VWD-key fob secret key may be established between the devices. The VWD-key fob secret key can be included in or used to generate a hashed message authentication code (HMAC), which can also include a header and a payload. The VWD-key fob secret key can be established using a Diffie Helman key exchange process, which includes providing the key fob 14 and the VWD 96 two prime numbers. One particular example of such key establishment and authentication process is discussed in more detail below in method 400 (FIG. 4). In other embodiments, an encryption scheme can be implemented according to public key encryption schemes. The method 300 continues to step 320.

In step 320, a key fob activation command is received. The key fob activation command can be an indication that a user desires to use or enable the key fob for use with the vehicle. The key fob activation command can be a wireless message that is sent from HWD 90 or other mobile device. Or, the key fob activation command can be input received from a user pressing button 112 or 114 of the key fob 14. This step may be carried out in response to user input into the car-sharing application 92. For example, a user may operate the car-sharing application 92 on the HWD 90 and request to activate or enable the key fob 14. The application may then request that the user press a button on the key fob. In some embodiments, the button press may then inform the key fob that the user is requesting to enable the key fob for use with the vehicle. The method 300 proceeds to step 330.

In step 330, an authorization to control at least some vehicle functions on the vehicle is received. This step may be implemented by carrying out one or more wireless messages between the HWD 90 and/or the VWD 96. For example, the key fob 14 can send a request for authorization message to the car sharing application 92 of the HWD 90. This request for authorization message can include a secret key (or a HMAC) that can be used by the application 92 to authenticate messages received from the key fob 14, and/or that may be used by the key fob to authenticate messages received from the HWD 90.

The HWD 90 can then send an enable key fob message to the VWD 96. The enable key fob message can include a secret key (or HMAC signature generated using the secret key) and may be sent to the vehicle, such as to VWD 96. The VWD 96 may then receive the enable key fob message and may then generate an access granted message that can be sent to the key fob 14. The access granted message can include the HMAC that includes the secret key that was established between the key fob 14 and the VWD 96, and may also include a delegated digital token or key. The delegated digital token or key can be included in vehicle command messages, as discussed below, such that the VWD 96 can verify the authorization of the key fob when vehicle commands are received. The method 300 proceeds to step 340.

In step 340, the transmissions of any one or more of the vehicle commands from the key fob are enabled. The key fob 14 can use processor 104 to allow transmissions of wireless vehicle command messages that include vehicle commands. The wireless messages can include a header, a payload, and a signature. The signature can be the HMAC signature that uses the shared secret key. The header can include certain metadata, and the payload can include the vehicle commands. The method 300 continues to step 350.

In step 350, a user input requesting that one of the vehicle commands be sent to the vehicle is received. The user input can be received through a user pressing button 112 and/or 114 on the key fob. Or, the user input can be received from the user coming into a certain predetermined range of the vehicle. For example, a user may press an unlock button on the key fob, which may then indicate that a user desires to unlock the vehicle. Also, the vehicle may detect the presence of the enabled key fob 14 (e.g., detection that the key fob is in the vehicle or near the vehicle) and, thus, may allow an operated to start the vehicle's ignition or activate the primary mover via a push-to-start button located in the vehicle or on the key fob. The method 300 continues to step 360.

In step 360, the requested one of the vehicle commands is sent to the vehicle. The vehicle command can be included in a wireless message, as discussed above. The key fob can send the vehicle command to the vehicle via the VWD 96 using SRWC, such as Bluetooth Low Energy™ (BLE). The wireless message that includes the vehicle commands can be encrypted using the VWD-key fob secret key, as discussed above, and may also include a HMAC signature. The wireless messages can also include the delegated digital token or key such that, when received at the vehicle, the vehicle can determine that the key fob presently has authorization to direct the vehicle to carry out certain commands. The method 300 continues to step 370.

In step 370, the authorization is removed such that the key fob is disabled from further controlling the vehicle functions. The authorization may be removed as a result of receiving a message from the vehicle, such as from the VWD 96. The authorization may be removed based on the expiration of a timer or the ending of a time range (e.g., the end of a predetermined time limit that was set by the user using application 92). In another embodiment, the HWD 90 can send a message to the key fob informing the key fob to remove the authorization. The removal of the authorization can include deleting the delegated digital token or key that was provided to the key fob by the vehicle. In another embodiment, the key fob may merely forgo sending any vehicle commands to the vehicle, at least until re-activated or enabled (e.g., such as in steps 320-330). The method 300 then ends.

With reference to FIG. 4, there is shown an embodiment of a method 400 of authenticating the key fob for use with a specific vehicle. This method may be used to pair the key fob and the vehicle such that, when requested, the key fob may be enabled to send one or more vehicle commands to the vehicle, which can then be used to control and/or operate the vehicle.

In steps 402 and 404 two predetermined prime numbers are provided to the vehicle wireless device 96 and to the key fob 14. A first number can be a base number “B” and a second number can be a modulus number “M”. These numbers may be stored in memory 106 of key fob 14 and in memory of VWD 96. Then, in step 406, an administrator may initiate a key exchange process, which includes steps 408-426. This process can be initiated by the administrator using certain equipment that generates and sends a request to generate a shared secret to the vehicle wireless device 96. In one embodiment, the key exchange process can be carried out according to a Diffie Helman key generation and exchange scheme.

In step 408, in response to receiving the request to generate a shared secret, the VWD 96 can send a connection request message to the key fob 14. This connection request message can include a media access control (MAC) address of the key fob (e.g., the MAC address of the Bluetooth circuitry on the key fob). Then, in step 410, when the key fob receives the connection request message, the key fob send a confirmation message back to the VWD 96. The key fob can carry out step 410 only if the MAC address is verified to correspond to the key fob. In step 412, in response to receiving the confirmation message from the key fob 14, the VWD 96 generates a secret (a VWD secret number “V”). Then, in step 414, the base number B, modulus number M, and the VWD secret number V are used in the following equation: B^{V} mod M. The result (the “part 1 key”) is then sent to the key fob 14.

In step 416, the key fob generates a secret (a key fob secret number “F”), which is then inputted, along with base number B and modulus number M, into the following equation: B^{F} mod M. This result (the “part 2 key”) is then sent to the VWD 96 in step 418. Then, in steps 420 and 422, the shared secret is generated. In step 420, the part 2 key received from the key fob 14 in step 418 is then inputted into the following equation: (part 2 key)^{V} mod M. In step 422, the part 1 key received from the key fob 14 in step 414 is then inputted into the following equation: (part 1 key)^{F} mod M. The result of both of steps 420 and 422 produces an identical shared key that can be used for carrying out secured and/or authenticated communications between the key fob 14 and the VWD 96.

In step 424, a confirmation message is sent from the key fob 14 to the VWD 96. This confirmation message can include a hashed-based message authentication code (HMAC) that can be used by the VWD 96 to verify the authenticity of the message (e.g., the fact that key fob 14 sent the message). The HMAC can be generated using the shared secret key (or the VWD-key fob secret). In step 426, this HMAC signature is verified by the VWD 96. The method 400 then ends.

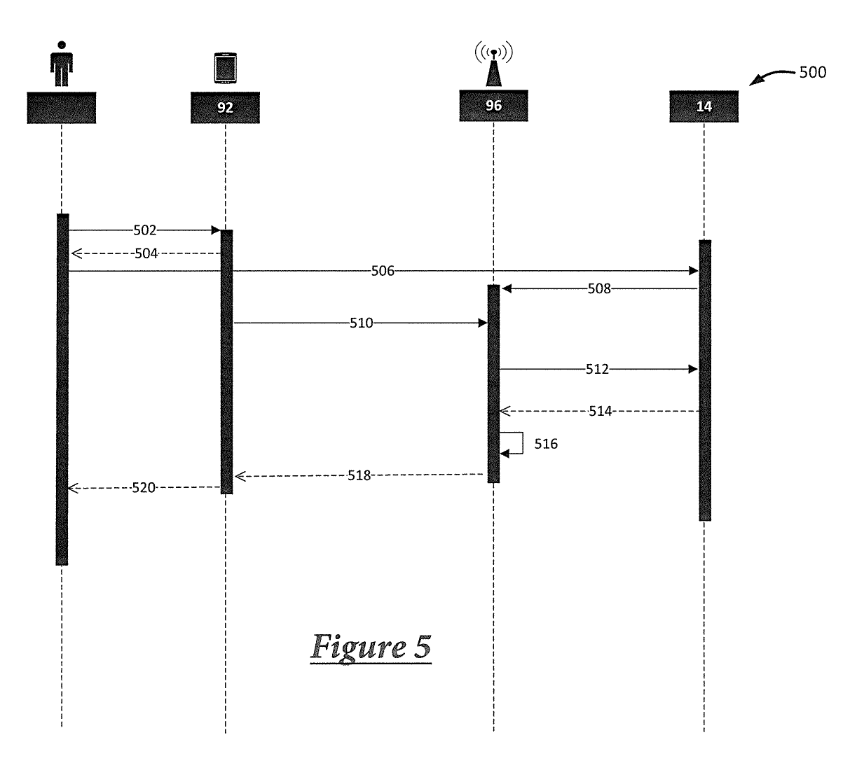

With reference to FIG. 5, there is shown an embodiment of a method 500 of authorizing a key fob to control the vehicle through sending vehicle commands. The method begins with step 502, wherein a user selects an option using the car sharing application 92 that indicates that the user desires that the key fob become activated. The user may convey this indication through pressing a button on a touchscreen of the HWD 90 or through using any other interfacing means. Then, at step 504, the HWD 90 can present a message or other indication to the user that the user should press a button (or perform some other operation) on the key fob. In step 506, the user presses the button on the key fob 14, which then wakes up the key fob (e.g., switches the key fob from a low power mode (or off mode) to a full-power or on mode). This button press may be referred to as a key fob activation command, as discussed above. In step 508, in response to receiving the key fob activation command, the key fob 14 can send an activation request message to the VWD 96. The activation request message can include a HMAC signature (as discussed above in method 400 (FIG. 4)).

In step 510, the car sharing application 92 can generate an enable key fob message that can be sent to the VWD 96. The enable key fob message can include a delegated digital key, an HMAC signature, and other information. The delegated digital key can be a digital key that is generated by the car sharing application 92 and which is based on the assigned digital key that was assigned to the HWD 90 as part of a user's reservation of vehicle 12. Alternatively, the delegated digital key can be the same as the assigned digital key. HWD 90 may have a pre-shared secret that it uses for communications with the VWD 96 and, in such cases, can use this pre-shared secret to encrypt and/or sign messages sent to the VWD 96. A public encryption scheme may be used as well. The enable key fob message is then sent to the VWD 96 using SRWC, such as BLE. Steps 508 and/or 510 may be carried out at the same time or in the reverse order than what is depicted in FIG. 5.

In step 512, after receiving the enable key fob message from the car sharing application 92 and/or the activation request message from the key fob 14, an access granted message can be generated using data in the enable key fob message, such as the delegated digital key. The access granted message can include an HMAC signature. The access granted message is then sent to the key fob 14. After receiving the access granted message, the key fob can store the delegated digital key into the memory 106. This delegated digital key may then be used later by the key fob to indicate the key fob's authorization to control the vehicle through sending vehicle commands (e.g., messages that include the delegated key and a vehicle command). The key fob may also set a “key fob enabled” status to true and/or modify other data such that the key fob may be able to send authorized vehicle commands to the vehicle 12.

In step 514, the key fob 14 can send a confirmation response to the VWD 96. This confirmation response can include the HMAC signature. Then, in step 516, “key fob enabled” status at the VWD 96 is set to true and/or modify other data such that the key fob may be able to send authorized vehicle commands to the vehicle 12. After step 516, step 518 is carried out where a confirmation message is sent to the car sharing application 92 that indicates that the key fob 14 has been enabled. Once this message is received by the car sharing application 92, in step 520, the car sharing application can notify the user that the key fob 14 is enabled by providing a visual notification on the touchscreen or using other interfacing means. The method 500 then ends.

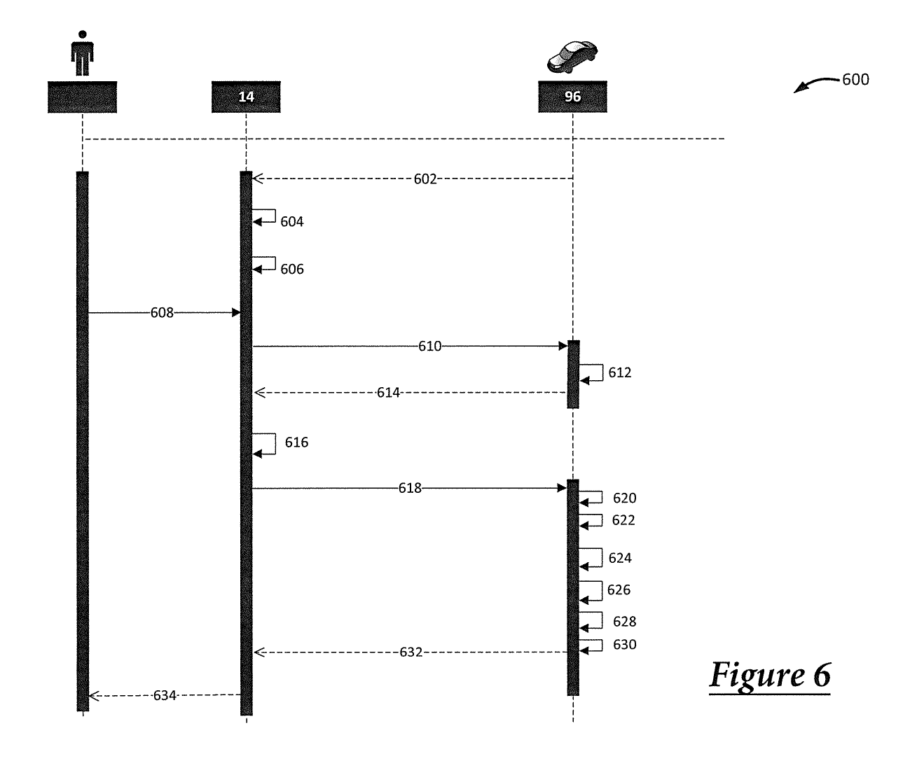

With reference to FIG. 6, there is shown an embodiment of a method 600 of using a key fob to send vehicle commands to a vehicle. In step 602, the key fob 14 receives an advertisement message from vehicle 12 (e.g., from VWD 96). This message can include a service identifier and/or a friendly name of the vehicle, such as a VIN number or derivative thereof. Then, in step 604, the key fob can verify that it is paired and that there is a connection available with the vehicle 12 and/or VWD 96. Then, in step 606, the key fob can determine if the “key fob enabled” flag is set to true (or otherwise determine that the key fob is enabled to send vehicle commands to the vehicle). Also, the key fob 14 can determine that the delegated vehicle key is stored on memory 106.

In step 608, a user presses a button 112 and/or 114 (or provides other input) on the key fob 14 which indicates a user's desire to command the vehicle. Certain buttons 112,114 or other inputs that can be received or generated at the key fob may be associated with certain vehicle commands, such as button 112 associated with an unlock command. Once the key fob realizes or receives the user input requesting that one of the vehicle commands be sent to the vehicle, the key fob 14 can generate a challenge request message to be sent to the VWD 96. The challenge request message can include data indicating that the message is a challenge request, a start date, an end date, an issue at date, and other information, including an HMAC signature. The challenge request message is sent to the vehicle (or VWD 96) via BLE or other SRWC communications at step 610. Then, in step 612, after having received the challenge request message from the key fob 14, the VWD 96 generates a vehicle challenge token that includes a unique identifier for that token. The unique identifier and/or vehicle challenge token are saved at memory device at the VWD 96 (or vehicle 12). Then, the vehicle challenge token and/or unique identifier are included in a vehicle challenge response message that is sent to the key fob 96 via BLE or other SRWC at step 614.

After receiving the vehicle challenge response message, the key fob 14 generates a command request message at step 616. The command request message includes the vehicle command that was indicated in the user input (at step 608) and also includes the vehicle challenge token (or certain information included therein, such as the vehicle challenge unique identifier), the delegated digital vehicle key, and an HMAC signature. The HMAC signature can be derived from the shared secret (see method 400), other data from the command request message, and/or other data from the vehicle challenge token. Once generated, the command request message is sent to the VWD 96 at step 618. At step 620, the VWD 96 receives the command request message and then retrieves the vehicle challenge token using the unique identifier that was generated and stored in memory in step 612.

Then, in step 622, the vehicle determines if the command request message was received from a delegated device (e.g., key fob 14) and, if so, then determines if the message was signed properly, that the key fob 14 is enabled (“key fob enabled” status is set to true), and that the delegation is allowed or appropriate. After this is determined to be true, then the method 600 continues to step 624. In step 624, the command request message is validated by extracting a public key from the delegated digital vehicle key and then verifying that the HMAC signature using the shared secret and certain other data in the command request message. Once verified, at step 626, the delegated digital vehicle key is verified. Then, at step 628, if the delegated digital vehicle key is successfully verified, other certain information in the command request message is verified, such as whether the delegation of vehicle access to the key fob is proper and/or allowed. If any one or more of the previous verifications (steps 622-628) fails, then the VWD 96 can reject the command request message and not carry out step 630. The VWD 96 may then send a message back to the key fob indicating that the message was rejected.

Next, in step 630, the command is executed by the vehicle. The command can be sent to the proper vehicle system module via bus 44. In step 632, the VWD 96 sends a confirmation that the command was executed to the key fob 96. In step 634, the key fob 14 can use LED 110 to indicate that the command was executed. In other embodiments, the key fob 14 may include speakers that indicate the command was executed or any other user interfacing/communication means.

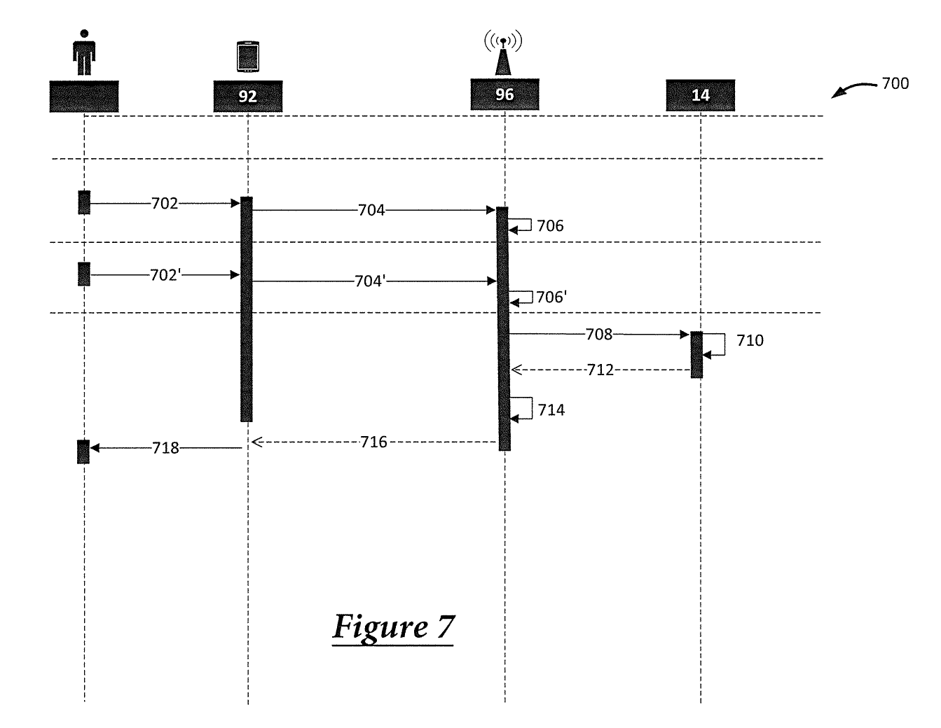

With reference to FIG. 7, there is shown an embodiment of a method 700 of removing the authorization from the key fob such that the key fob is disabled from further controlling the vehicle functions. The method 700 begins with step 702 wherein the user's reservation ends early. The user may indicate his/her desire to end the reservation early using the car sharing application 92, such as through pressing a button on a touchscreen of HWD 90. Then, at step 704, the car sharing application 92 generates and sends an end reservation message to the VWD 96. The end reservation message can include an HMAC signature that is generated using the shared secret key (see method 400). Once the VWD 96 receives the end reservation message, at step 706, the VWD 96 ends the reservation, which can include configuring itself or one or more vehicle system modules such that the user's access is no longer permitted (e.g., the delegated digital vehicle key is disabled, no longer valid, and/or deleted).

Alternatively, steps 702′-706′ may be carried out in place of steps 702-706. In step 702′, the user selects a disable key fob option using the car sharing application 92. This can be carried out by the user pressing a button on a touchscreen of HWD 90. Then, in step 704′, the car sharing application 92 generates a disable key fob request, which is signed with the HMAC (using the shared secret key). This disable key fob request is then sent to the VWD 96. At step 706′, the VWD 96 can perform any necessary or desired operations in response to receiving the disable key fob request, or may proceed directly to step 708.

At step 708, which can occur after steps 702-706 or 702′-706′, the VWD 96 generates a disable key fob command, which includes a HMAC signed using the shared secret key. This disable key fob command is then sent to the key fob 14. Then, at step 710, the key fob 14 deletes the delegated digital vehicle key and sets the “key fob enabled” status to false. Then, in step 712, the key fob 96 sends a key fob disabled confirmation message to the VWD 96, which can also be signed using the HMAC with the shared secret key. Then, in step 714, the VWD 96 can set certain flags and/or make certain changes such that the key fob will no longer be enabled. In step 716, a disable confirmation message is sent to the car sharing application 92. Next, in step 718, the car sharing application 92 can then notify the user using one or more user-device interfaces that the key fob 14 has been disabled. The method 700 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the HWD 90 and its car sharing app 92 may be used for providing additional back office functions as a part of the car sharing system 10; this includes providing various types of information to the remote computer 78 or remote facility 80, such as vehicle information obtained by VWD over the bus 44—this may include location information using the GPS module 22, or odometer readings at the beginning and end of a reservation. Information concerning the utilization of key fob 14 may also be provided by way of its connection via SRWC to the VWD 96 which then provides the information to HWD 90 also via SRWC. HWD 90, using its application 92, may then pass the information via cellular or a SRWC link to the Internet back to computer 78 or remote facility 80. This key fob information may include data about the key fob's utilization by customers, as well as operating information such as its battery state of charge so that the back office may provide notification to the car sharing service operator servicing that vehicle that the battery needs to be replaced. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

1. A method of operating a key fob for use in a car sharing system, comprising the steps of:
authenticating the key fob for use with a specific vehicle, the key fob being associated with a set of vehicle commands that may be sent wirelessly from the key fob to the vehicle, wherein the key fob can be activated and deactivated wirelessly to selectively enable and disable sending of the vehicle commands;
receiving a key fob activation command;
obtaining an authorization to control, using the vehicle commands, at least some vehicle functions on the vehicle;
in response to obtaining the authorization, enabling transmissions of any one or more of the vehicle commands from the key fob;
receiving a user input requesting that one of the vehicle commands be sent to the vehicle;
sending the requested one of the vehicle commands to the vehicle; and
subsequently removing the authorization such that the key fob is disabled from further controlling the vehicle functions.

2. The method of claim 1, wherein the authentication step includes pairing the key fob to a vehicle wireless device (VWD) installed in the vehicle, wherein the sending step is carried out via the VWD.

3. The method of claim 1, wherein the authentication step includes obtaining a secret key that can be used to carry out secure wireless communications with a vehicle wireless device (VWD) or other vehicle system module of the vehicle.

4. The method of claim 1, wherein the key fob activation command is received from a handheld wireless device (HWD) or from a user via a button included on the key fob.

5. The method of claim 1, wherein the step of receiving a key fob activation command is carried out in response to user input into an application on a handheld wireless device (HWD).

6. The method of claim 1, wherein the obtaining authorization step includes sending a activation request message to a handheld wireless device (HWD) and, subsequently, receiving a delegated digital key from a vehicle wireless device (VWD), wherein the delegated digital key provides the key fob with authorization to control one or more of the vehicle functions.

7. The method of claim 6, further comprising the step of sending a confirmation response message to the VWD in response to the obtaining authorization step.

8. The method of claim 6, wherein the step of receiving the delegated digital key comprises receiving at the key fob from the VWD an access granted message that includes the delegated digital key and that is signed using a secret key that was established during the authentication step.

9. The method of claim 6, further comprising the steps of:
sending a challenge request message to the VWD in response to the receiving user input step; and
receiving a challenge response message from the VWD in response to sending the challenge request message to the VWD, wherein the challenge response message includes a vehicle challenge token.

10. The method of claim 1, wherein the user input is via a button on the key fob.

11. The method of claim 1, wherein the removing step includes disabling any further transmissions of the vehicle commands from the key fob.

12. The method of claim 1, wherein the removing step is carried out based on a predetermined time limit, on receipt of a disable key fob command from a handheld wireless device (HWD), or on receipt of the disable key fob command from a vehicle wireless device (VWD).

13. A method of controlling a key fob for use in a car sharing system, comprising the steps of:
obtaining vehicle access credentials at a user's handheld wireless device (HWD), wherein the vehicle access credentials include a digital vehicle key that allows the user to access and/or operate the vehicle through sending of vehicle commands to the vehicle, wherein the vehicle commands instruct the vehicle to carry out one or more vehicle functions;
activating a key fob for use with the vehicle using the HWD; and
controlling one or more vehicle functions via manual input to the key fob.

14. The method of claim 13, wherein the activation step includes sending an enable key fob message to a vehicle wireless device (VWD) installed in the vehicle, and wherein the receipt of the enable key fob message by the VWD causes the VWD to carry out communications with the key fob to enable the key fob for sending vehicle commands to the vehicle.

15. The method of claim 14, wherein the activation step includes sending an activation request message from the key fob to the HWD.

16. The method of claim 13, further comprising the step of sending a disable key fob request to a vehicle wireless device (VWD).

17. The method of claim 16, further comprising the step of receiving a disable confirmation message from the VWD, wherein the disable confirmation message indicates that the key fob has been disabled from controlling the one or more vehicle functions.

18. A key fob comprising a housing, one or more manual input sensors, a short range wireless communications (SRWC) circuit, an electronic processor connected to receive input from the sensor(s) and to send and receive messages via the SRWC circuit, computer-readable memory, a program stored in the memory and operable upon execution by the processor to cause the processor to process inputs received via the sensor(s) and messages received via the SRWC circuit and to send via the SRWC circuit vehicle commands based on the received inputs and/or messages;
wherein the processor is operable under control of the program to send the vehicle commands only when enabled via one or more messages received via the SRWC circuit.
